(19) United States
(12) Patent Application Publication
(10) Pub. No.: US 2009/0315482 A1
(43) Pub. Date: Dec. 24, 2009

(54) Light emitting apparatus capable of controlling lighting color and method thereof

(76) Inventors: Ko Yung Yu, Taoyuan City (TW); I-van Su, Taipei City (TW)

Correspondence Address: COVENANT IP CONSULTING CO., P.O. BOX 34-306 TAIPEI CITY, TAIPEI, 10499, TW

(21) Appl. No.: 12/143,817

(22) Filed: Jun. 22, 2008

(51) Int. Cl. H05B 41/36

(52) U.S. Cl. 315/307

(57) ABSTRACT

A light emitting apparatus and a method for controlling the same are provided. The light emitting apparatus comprises a color-temperature relation stored in a memory, a thermometer or temperature acquiring means for acquiring a temperature reading, a processor for comparing the temperature reading with the color-temperature relation and determining a lighting color, and a light emitting unit for emitting the lighting color determined by the processor.

### BACKGROUND

The present invention relates generally to a lighting apparatus and a method for controlling lighting colors, and more specifically, to a lighting apparatus and a method for controlling lighting colors according to the environmental temperature and/or other environmental conditions.

Conventional lighting system has been confined to a single color. Lighting apparatuses such as light bulbs or fluorescent lights are capable of producing only one lighting color. It is sometimes in the interest of a user to change the lighting colors in a room. Conventionally, the user needs separate lighting apparatuses to generate different lighting colors.

With the advancement of light emitting diode (LED) technology, the use of LED lighting apparatus is gaining popularity. LED lighting systems are capable of generating a variety of colors with a single lighting apparatus. The variety of lighting colors can be accomplished by converging the colors of different light emitting diodes in the LED lighting apparatus. An example of different light emitting diodes can be a red light emitting diode, a green light emitting diode, and a blue light emitting diode.

Different colors are perceived and felt by humans differently. For example, red is often observed as a color of passion and is considered to be a warm color, and blue is often thought to be a color of calmness and is considered to be a cool color.

U.S. Pat. No. 7,119,503 discloses an apparatus and a method for displaying a color that reflect the measured temperature of an object. However, currently there is no lighting system that determines the lighting color according to the environmental temperature and/or other environmental conditions.

### SUMMARY OF INVENTION

The present invention discloses a light emitting apparatus comprising a light emitting diode unit, a temperature acquiring means for acquiring a temperature reading, a memory for storing a predetermined color-temperature relation, and a processor. The light emitting diode is capable of generating light in a variety of colors. The processor is capable of receiving the temperature reading from the temperature acquiring means, accessing the memory, and determining the color of the light to be generated by the light emitting diode unit. The color of the light generated by the light emitting diode unit is determined by the processor according to the temperature reading and the predetermined color-temperature relation.

The present invention also discloses a method for controlling lighting color of a lighting apparatus. The method comprises storing a color-temperature relation in a memory, determining a temperature reading, and generating the lighting color according to the temperature reading and the color-temperature relation.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is the block diagram of a light emitting apparatus of an embodiment of the present invention.

FIG. 2 is the block diagram of a light emitting apparatus of another embodiment of the present invention.

FIG. 3 is the block diagram of a light emitting apparatus of another embodiment of the present invention.

FIG. 4 is the flowchart of a method for controlling lighting color of a lighting apparatus in accordance to an embodiment of the present invention.

FIG. 5 is the flowchart of a method for controlling lighting color of a lighting apparatus in accordance with another embodiment of the present invention.

FIG. 6 is an exemplary table of a color-temperature relation in accordance to an embodiment of the present invention.

FIG. 7 is an exemplary table of an intensity-time relation in accordance to an embodiment of the present invention.

### DETAILED DESCRIPTION

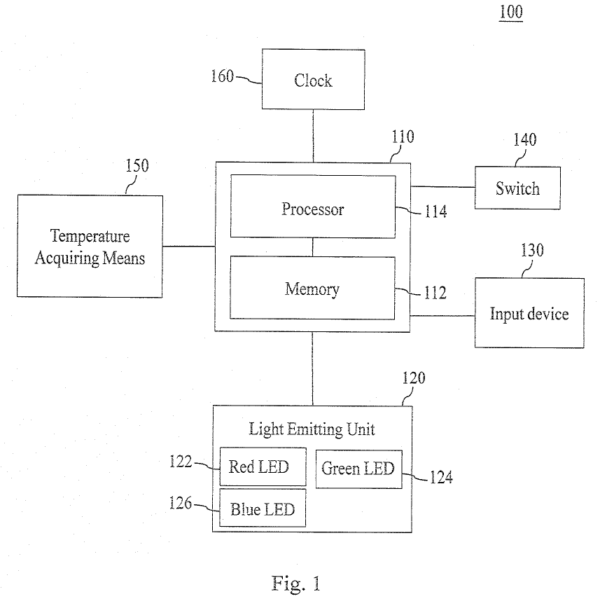

FIG. 1 is the block diagram of a light emitting apparatus 100 of an embodiment of the present invention. The light emitting apparatus comprises a processing unit 110 having a memory 112 and a processor 114 connected to each other, a light emitting unit 120 connected to the processing unit 110, an input device 130 connected to the processing unit 110, a switch 140 connected to the processing unit 110, a temperature acquiring means 150 connected to the processing unit 110, and a clock 160 connected to the processing unit 110. The memory 112 stores a predetermined color-temperature relation and an intensity-time relation.

When the switch 140 of the light emitting apparatus 100 is switched on, the processor 114 receives a temperature reading from the temperature acquiring means 150 and accesses the color-temperature relation stored in the memory 112. The processor 114 determines a lighting color to be emitted by the light emitting diode unit 120 by comparing the received temperature reading with the color-temperature relation. In one example, the lighting color is determined to be red when the temperature is below 50° F. so the room would appear to be warmer. In another example, the lighting color is determined to be blue when the temperature is above 90° F. so the room would appear to be cooler. However, the color-temperature relation is not limited to the above examples.

To obtain the temperature reading, the temperature acquiring means 150 can be a thermometer connected to the processor 114 by wire or wirelessly. The temperature acquiring means 150 can also be an input device 130 such as a keypad, a keyboard, or a computer mouse that a user uses to input the temperature reading.

The processor 114 can also determine the intensity of the light emitting diode unit 120. The processor 114 receives the time from the clock 160 and accesses the intensity-time relation stored in the memory, and the processor 114 determines the intensity of the light emitting diode unit 120 by comparing the time and the intensity-time relation. In one example, the intensity of blue lighting color is higher during summer at noon than at night. In another example, the intensity of red lighting color is lower during winter at noon than at night. However, the intensity-time relation is not limited to the above examples.

Light emitting diodes (LED) are capable of converging different colors to emit colors of choice. The light emitting diode unit 120 comprises light emitting diodes of different colors. In the current embodiment, the light emitting diode unit comprises a red light emitting diode (Red LED) 122, a green light emitting diode (Green LED) 124, and a blue light emitting diode (Blue LED) 126. The lighting color determined by the processor 114 is generated by converging the light generated by the red light emitting diode 122, the light generated by the green light emitting diode 124, and the light generated by the blue light emitting diode 126. However, the light emitting diode unit 120 can comprise any combination of light emitting diodes with two or more colors.

The color-temperature relation and the intensity-time relation stored in the memory can be predetermined. However, in the current embodiment, the two relations can also be user-defined. The input device 130 connected to the processing unit 110 allows a user to input and store the relations into the memory 112. The input device 130 may be a keyboard, a keypad, a computer mouse, a dial, or a touch panel.

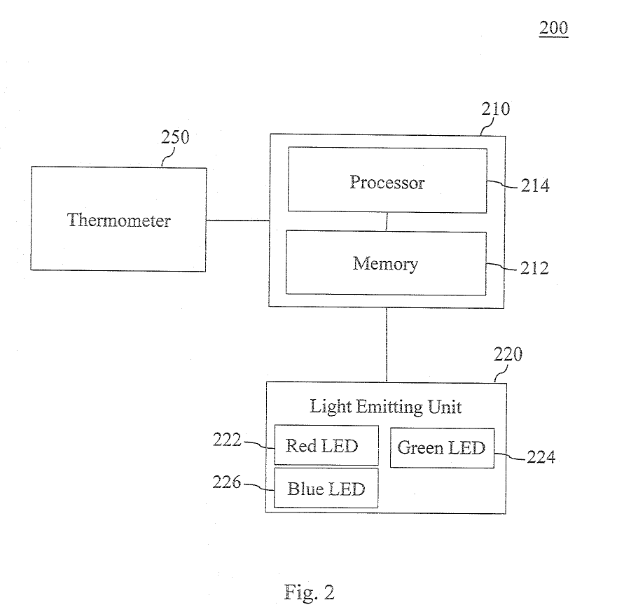

FIG. 2 is a light emitting apparatus of another embodiment of the present invention. The light emitting apparatus 200 comprises a processing unit 210 having a memory 212 and a processor 214 connected to each other, a light emitting unit 220 connected to the processing unit 210, and a thermometer 250 connected to the processing unit 210. The memory 212 stores a predetermined color-temperature relation.

The processor 214 receives a temperature reading from the thermometer 250 and accesses the color-temperature relation stored in the memory 212. The processor 214 determines a lighting color to be generated by the light emitting diode 220 by comparing the received temperature reading with the color-temperature relation. The thermometer 250 can be located inside the room where the lighting emitting apparatus 200 is in, or it can be located outside to measure the temperature of the surrounding environment.

In order to generate the determined lighting color by the light emitting diode unit 220, the light emitting diode unit 220 comprises light emitting diodes of different colors and converges the lights of light emitting diodes with different colors into the determined lighting color. In the current embodiment, the light emitting diode unit comprises a red light emitting diode (Red LED) 222, a green light emitting diode (Green LED) 224, and a blue light emitting diode (Blue LED) 226.

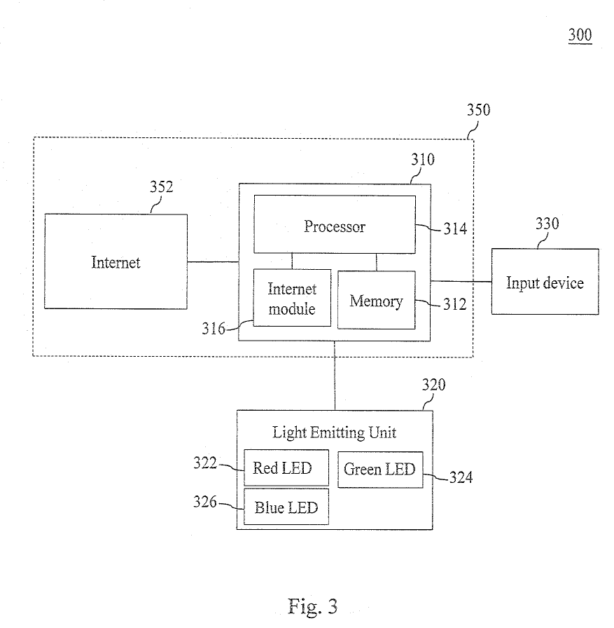

FIG. 3 is a light emitting apparatus 300 of another embodiment of the present invention. The light emitting apparatus 300 comprises a processing unit 310 having a memory 312, a processor 314, and an internet module 316 capable of accessing internet 352. The light emitting apparatus 300 further comprises a light emitting diode unit 320 connected to the processing unit 310, and a temperature acquiring means 350. The memory 312 stores a predetermined color temperature relation.

The processor 314 receives a temperature reading from the temperature acquiring means 350 and accesses the color-temperature relation stored in the memory 312. The processor 314 determines a lighting color to be emitted by the light emitting diode 320 by comparing the received temperature reading with the color-temperature relation.

The temperature acquiring means 150 is the combination of the processing unit 310 and the internet 352. The internet module 316 of the processing unit 310 accesses the internet 352 and downloads a temperature reading from a website providing local temperatures. To access temperature readings from the website, the processing unit 310 connects to a predetermined website and downloads the temperature reading from the website directly, or by the user entering a zip code or a city name on the website via an input device 330. The input device 330 can be a keypad, a keyboard, a computer mouse, a dial, and a touch panel or equivalents.

In order to generate the determined lighting color by the light emitting diode unit 320, the light emitting diode unit 320 comprises light emitting diodes of different colors and converges the lights of light emitting diodes with different colors into the determined lighting color. In the current embodiment, the light emitting diode unit comprises a red light emitting diode (Red LED) 322, a green light emitting diode (Green LED) 324, and a blue light emitting diode (Blue LED) 326.

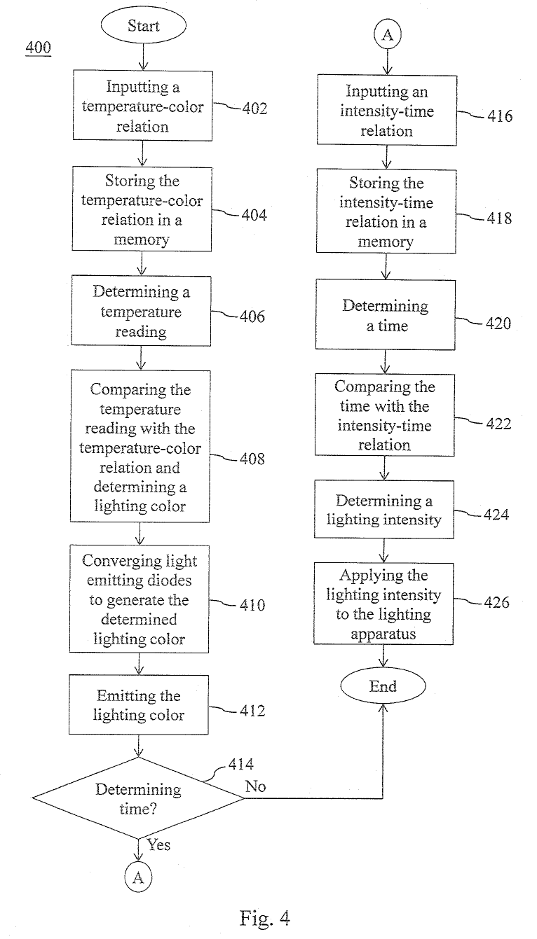

FIG. 4 is a flowchart of a method for controlling lighting color of a lighting apparatus in accordance to an embodiment of the present invention. The method comprises inputting a color-temperature relation 402, storing the color-temperature relation to a memory 404, determining a temperature reading 406, comparing the temperature reading with the color-temperature relation and determining a lighting color 408, converging light emitting diodes with different colors to generate the determined lighting color 410, and emitting light with the determined lighting color 412.

The method further comprises determining whether there are other parameters to be determined for the lighting conditions emitted by the lighting apparatus 414. If no, the method ends. If yes, the method further comprises inputting an intensity-time relation 416, storing the intensity-time relation to the memory 418, determining a time 420, comparing the time with the intensity-time relation 422, determining a lighting intensity 424, and applying the intensity to the lighting apparatus 426.

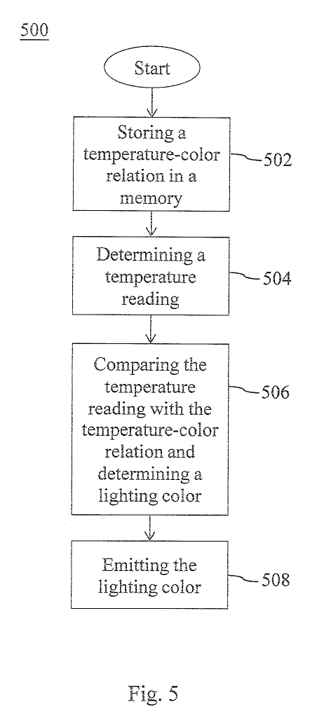

FIG. 5 is a flowchart of a method for controlling lighting color of a lighting apparatus in accordance to another embodiment of the present invention. The method comprises storing a color-temperature relation in a memory 502, determining a temperature reading 504, comparing the temperature reading with the color-temperature relation and determining a lighting color 506, and emitting light with the determined lighting color 508.

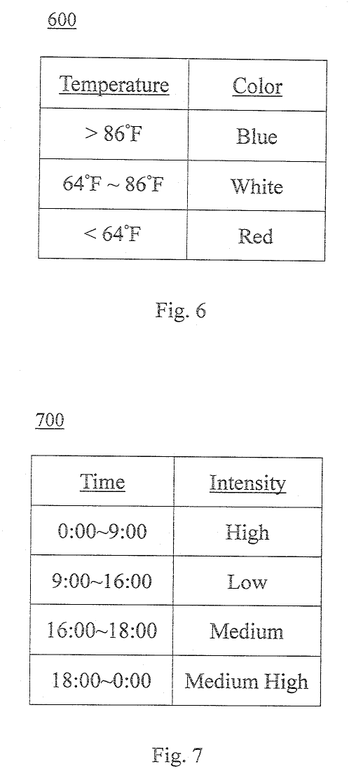

FIG. 6 is a table of a color-temperature relation stored in a memory of a light emitting apparatus of an embodiment of the present invention. Table 600 shows an example of a list of colors corresponding to different temperature readings. The lighting color to be emitted is determined according to the temperature reading and the color-temperature relation in table 600. For example, when the temperature reading received is below 64° F., the lighting color is determined to be reddish according to the temperature-color relation in table 600. When the temperature reading received is above 86° F., the lighting color is determined to be bluish according to the color-temperature relation in table 600. Table 600 is for demonstration purpose only; a more complicated table of color-temperature relation can be stored to cover a wide range of temperatures and colors.

FIG. 7 is a table of an intensity-time relation stored in a memory of a light emitting apparatus of an embodiment of the present invention. Table 700 shows an example of a list of intensities corresponding to different times. The lighting intensity is determined according to the time and the intensity-time relation in table 700. For example, when a user turns on the lighting apparatus at 8 o'clock in the morning, the intensity of the lighting is determined to be high according the intensity-time relation in table 700. Table 700 is for demonstration purpose only.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A light emitting apparatus, comprising:
a light emitting diode unit, which is capable of generating light in a variety of colors;
a temperature acquiring means for acquiring a temperature reading;
a memory for storing a predetermined color-temperature relation; and
a processor, which is capable of receiving the temperature reading from the temperature acquiring means, accessing the memory, and determining the color of the light generated by the light emitting diode unit;
wherein the processor determines the color of the light generated by the light emitting diode unit according to the temperature reading and the predetermined color-temperature relation.

2. The light emitting apparatus of claim 1, wherein the light emitting diode unit comprises a red light emitting diode, a green light emitting diode, and a blue light emitting diode.

3. The light emitting apparatus of claim 2, wherein the color of the light generated from the light emitting diode unit is converged from the light generated by the red light emitting diode, the light generated by the green light emitting diode, and the light generated by the blue light emitting diode.

4. The light emitting apparatus of claim 1 further comprising an input device for setting the predetermined color-temperature relation.

5. The light emitting apparatus of claim 4, wherein the input device is a keyboard.

6. The light emitting apparatus of claim 4, wherein the input device is touch panel.

7. The light emitting apparatus of claim 1 further comprising a clock and a predetermined intensity-time relation stored in the memory, wherein the processor determines an intensity of the light generated by the light emitting diode unit according to the clock time and the predetermined intensity-time relation.

8. The light emitting apparatus of claim 1, wherein the temperature acquiring means is a thermometer.

9. A method for controlling lighting color, comprising:
storing a color-temperature relation in a memory;
determining a temperature reading;
comparing the temperature reading to the color-temperature relation stored in the memory; and
generating the lighting color according to the temperature reading and the color-temperature relation.

10. The method of claim 9, further comprising converging different colors of light to generate the lighting color.

11. The method of claim 9, further comprising inputting the color-temperature relation to the memory.

12. The method of claim 9, further comprising determining the time, storing an intensity-time relation in the memory, and determining the lighting intensity according to the time and the intensity-time relation.

13. The method of claim 12, further comprising inputting the intensity-time relation to the memory.

14. A light emitting apparatus, comprising:
a light emitting diode unit, which is capable of generating light in a variety of colors;
a thermometer for acquiring a temperature reading;
a memory for storing a predetermined color-temperature relation; and
a processor, which is capable of receiving the temperature reading from the thermometer, accessing the memory, and determining the color of the light generated by the light emitting diode unit;
wherein the processor determines the color of the light generated by the light emitting diode unit according to the temperature reading and the predetermined color-temperature relation.

15. The light emitting apparatus of claim 14, wherein the light emitting diode unit comprises a red light emitting diode, a green light emitting diode, and a blue light emitting diode.

16. The light emitting apparatus of claim 15, wherein the color of the light generated from the light emitting diode unit is converged from the light generated by the red light emitting diode, the light generated by the green light emitting diode, and the light generated by the blue light emitting diode.

17. The light emitting apparatus of claim 14 further comprising an input device for setting the predetermined color-temperature relation.

18. The light emitting apparatus of claim 17, wherein the input device is a keypad.

19. The light emitting apparatus of claim 17, wherein the input device is a dial.

20. The light emitting apparatus of claim 14 further comprising a clock and a predetermined intensity-time relation stored in the memory, wherein the processor determines an intensity of the light generated by the light emitting diode unit according to the clock time and the predetermined intensity-time relation.
